(19) United States
(12) Patent Application Publication
(10) Pub. No.: US 2009/0221453 A1
(43) Pub. Date: Sep. 3, 2009

(54) Treatment Fluid With Oxidizer Breaker System and Method

(76) Inventors: Sumitra Mukhopadhyay, Sugar Land, TX (US); Don Williamson, Katy, TX (US); Richard D. Hutchins, Sugar Land, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/363,917

(22) Filed: Feb. 2, 2009

Related U.S. Application Data
(60) Provisional application No. 61/032,497, filed on Feb. 29, 2008.

(51) Int. Cl. C09K 8/70; C09K 8/90; C09K 8/68; C09K 8/74

(52) U.S. Cl. 507/202; 507/211; 507/214; 507/219; 507/269

(57) ABSTRACT

A treatment fluid composition for treating a subterranean formation is formed from an aqueous fluid, a hydratable polymer and a polymer breaking system. The polymer breaking system includes an oxidizing breaking agent and an activator capable of providing a bisulfite ion source. A method of treating a subterranean formation may also be performed by forming a treatment fluid comprising an aqueous hydrated polymer solution and a polymer breaking system. The polymer breaking system includes a breaking agent of an oxidizer and an activator capable of providing a bisulfite ion source. The treatment fluid is introduced into the formation.

### CROSS-REFERENCE TO RELATED APPLICATIONS

This application claims the benefit of U.S. Provisional Application No. 61/032,497 filed Feb. 29, 2008, which is hereby incorporated by reference in its entirety.

### TECHNICAL FIELD

The present invention relates to treatment fluids for use in treating subterranean formations. In particular, the invention relates to viscosified treatment fluids and compositions and methods for breaking such fluids.

### BACKGROUND

The statements in this section merely provide background information related to the present disclosure and may not constitute prior art.

Carbohydrate polymers are used as viscous fracturing fluids in the oil and gas industry. These polymers may be cross-linked with various ions, such as boron, zirconium, and titanium, to further increase their viscosity. Polysaccharides, such as guar and guar derivatives, are commonly used to viscosify water-based fluids for fracturing treatments and for proppant transport. The proppant remains in the produced fracture in order to keep the fracture open and create a conductive channel extending from the well bore into the formation along the fracture length. After the fracture is complete, the recovery of the fracturing fluid is crucial to accelerate hydrocarbon production through the formed channel.

In part, the recovery of the fracturing fluid is achieved by reducing the viscosity of the fluid such that the fluid flows naturally through the proppant pack. Chemical reagents, such as oxidizers, chelants, acids and enzymes are typically employed to break the polymer networks to reduce their viscosity. These materials are commonly referred to as “breakers” or “breaking agents.”

The timing of the breaking is important. Gels broken prematurely can cause proppant to settle out of the fluid before reaching a sufficient distance into the produced fracture and result in a premature screen-out. Premature breaking can also result in less desirable fracture width in the created fracture. On the other hand, too much delay in breaking the gel is also undesirable. Delayed breaking can cause significant setback in the hydrocarbon production. These factors, including reactivity levels versus temperature, delay mechanisms, and insufficient cleanup of the proppant pack impose significant complexity in designing a successful breaker system.

Bromate salts of ammonia or alkaline metals (lithium, sodium or potassium) are strong oxidizing agents. These salts and their encapsulated forms are widely used as breakers for guar-based fracturing fluids, including guar, hydroxypropyl guar (HPG), carboxymethyl hydroxypropyl guar (CMHPG), and carboxymethyl guar (CMG).

Transition metal compounds (copper chloride and manganese sulfate) have also been reported as catalysts for bromate to allow use at lower temperatures. Similar catalysts are employed with sodium chlorite, another oxidizing agent.

Bromate breakers are effective in oxidizing guar-based crosslinked polymers at temperatures of 250° F. (121° C.) or higher. It would be useful to have activators for such bromate breakers and other oxidizing breakers capable of making them effective at lower temperatures.

Accordingly, a need exists for a breaker system that overcomes these limitations.

### SUMMARY

A treatment fluid composition for treating a subterranean formation is formed from an aqueous fluid, a hydratable polymer and a polymer breaking system. The polymer breaking system includes an oxidizing breaking agent and an activator capable of providing a bisulfite ion source. The breaking agent, the activator or both may be in encapsulated form, coated form or contained in a suspension. In certain embodiments, the composition also contains a crosslinking agent capable of crosslinking the hydratable polymer.

A method of treating a subterranean formation may also be performed by forming a treatment fluid comprising an aqueous hydrated polymer solution and a polymer breaking system. The polymer breaking system includes a breaking agent of an oxidizer and an activator capable of providing a bisulfite ion source. The treatment fluid is introduced into the formation to carry out the treatment, which may include a fracturing operation or a gravel packing operation. The step of introducing the treating fluid into the formation may include injecting the treatment fluid into a portion of the formation having a static temperature from about 25° C. to about 177° C. In some applications, the treatment fluid may be introduced at a pressure above the fracture pressure of the formation.

The oxidizing breaking agent may be selected from at least one of a bromate breaking agent, a chlorite breaking agent, a peroxide breaking agent, a perborate breaking agent, a percarbonate breaking agent, a perphosphate breaking agent, or a persulfate breaking agent. The breaking agent may also include an alkaline metal bromate, ammonium bromate or an alkaline earth bromate. In certain embodiments the bromate breaking agent is selected from at least one of potassium, sodium, lithium or ammonium bromate.

The activator may be a bisulfite ion source that is selected from alkaline metal solids or solutions of bisulfite, alkaline metal solids or solutions of metabisulfite, ammonium solids or solutions of bisulfite, ammonium solids or solutions of metabisulfite, alkaline earth solutions of bisulfite and alkaline earth solutions of metabisulfite. In certain instances the activator is selected from sodium bisulfite, potassium bisulfite, ammonium bisulfite, lithium bisulfite, sodium metabisulfite, potassium metabisulfite, ammonium metabisulfite and lithium metabisulfite.

In certain embodiments, the polymer may be selected from polysaccharides, galactomannans, guar, guar gums, guar derivatives, cellulose and cellulose derivatives, polyacrylamides, partially hydrolyzed polyacrylamides, copolymers containing acrylamide and other monomers including acrylic acid, methacrylic acid, quaternary ammonium salts derived from acrylamide or acrylic acid, dimethyldiallylammonium chloride, acrylamidomethylpropanesulfonic acid, acrylamidoethyltrimethylammonium chloride, N-vinyl pyrrolidone, N-vinyl formamide, N-vinyl acetamide, maleic acid, itaconic acid, vinylsulfonic acid, vinylphosphonic acid, and sulfonate containing monomers, and heteropolysaccharides having a tetrasaccharide repeating unit in the polymer backbone as represented by the chemical formula:

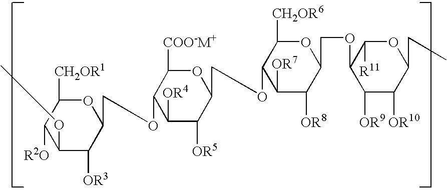

wherein at least three different saccharides are present in the repeating unit, such saccharides including D-glucose, D-glucuronic acid, and either L-rhamnose or L-mannose; M⁺ is an ionic species; R¹, R², R³, R⁴, R⁵, R⁶, R⁷, R⁸, R⁹, and R¹⁰ are selected from the group consisting of hydrogen, methyl, acetyl, glyceryl, or a saccharide group containing one to three saccharides units; R¹¹ is a methyl or methylol group; and the weight average molecular weight (Mw) for the heteropolysaccharide is from about 10⁵ to about 10⁷.

In some applications, the breaking agent is combined with the treating fluid in an amount from greater than 0% to about 200% by weight of the polymer in the treatment fluid and the activator is combined with the treating fluid in an amount of from about 1 to about 200% by weight of the polymer in the treatment fluid. In other applications, the breaking agent may be combined with the treating fluid in an amount from about 8% to about 80% by weight of the polymer in the treatment fluid and the activator is combined with the treating fluid in an amount from about 4% to about 40% by weight of the polymer in the treatment fluid.

A breaking delay agent may also be included in the treatment fluid. The breaking delay agent may be selected from at least one of NaNO₂, NaNO, Na₂S₂O₃, triethanol amine, thiourea and urea.

### BRIEF DESCRIPTION OF THE DRAWINGS

For a more complete understanding of the present invention, and the advantages thereof, reference is now made to the following descriptions taken in conjunction with the accompanying figures, wherein:

FIG. 1 shows a plot of the viscosity over time of a crosslinked guar fluid using sodium bromate/sodium bisulfite breaker systems at 175° F. (79.4° C.);

FIG. 2 shows a plot of the viscosity over time of a crosslinked guar fluid using sodium bromate and encapsulated sodium metabisulfite breaker systems at 175° F. (79.4° C.);

FIG. 3 shows a plot of the viscosity over time of a crosslinked guar fluid with 4% potassium chloride using sodium bromate and encapsulated sodium metabisulfite breaker systems at 175° F. (79.4° C.);

FIG. 4 shows a plot of the viscosity over time of a crosslinked guar fluid using sodium chlorite/sodium bisulfite breaker systems at 175° F. (79.4° C.); and

FIG. 5 shows a plot of the viscosity over time of a crosslinked guar fluid using ammonium persulfate/sodium bisulfite breaker systems at 100° F. (37.8° C.).

### DETAILED DESCRIPTION

At the outset, it should be noted that in the development of any actual embodiment, numerous implementation-specific decisions must be made to achieve the developer's specific goals, such as compliance with system related and business related constraints, that will vary from one implementation to another. Moreover, it will be appreciated that such a development effort might be complex and time consuming but would nevertheless be a routine undertaking for those of ordinary skill in the art having the benefit of this disclosure.

The description and examples are presented herein solely for the purpose of illustrating the various embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a range listed or described as being useful, suitable, or the like, is intended that any and every number within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range. The ranges of concentrations are understood to be active amounts of the stated component and do not include inactive unless so stated.

The present invention is directed toward breaking fracturing fluids or viscosified fluids in a controlled fashion using chemical oxidizers. When used alone certain breakers require high temperatures. For example, bromate breakers tend to require higher temperatures to activate; typically, bromate breakers are ineffective below about 250° F. (˜121° C.) for this purpose. By use of a suitable activator, the effective temperature for breaking a polymer can be lowered substantially. For example, sodium chlorite can typically be activated at a temperature of 175° F. (79.4° C.) with the use of catalytic metals. Ammonium persulfate can be activated at temperatures below about 125° F. (51.7° C.) by using certain amines.

When an oxidizing salt, such as a bromate salt, is combined with a source of bisulfite ions, such as sodium bisulfite or metabisulfite (MBS), the breaking system thus produced is an excellent oxidizing agent for organic molecules, including those with alcohol, diol, and ether functionalities, and has application at lower temperatures than those where no activator or promoter is used. The breaking agent may be an oxidizer such as ammonium, lithium, sodium or potassium bromate salt that serves as an oxidizing agent for degrading the polymer in solution. Although the breaking systems described herein have particular application to bromate-containing breaking systems, it should be noted that it has application to other oxidizing breakers, such as inorganic oxidizers and organic peroxides (e.g. salts of chlorite, and persulfate or benzoyl peroxide). Thus, where bromate breakers are discussed it should be understood that other oxidizers could also be used and have equal application to the present invention. Because bromate breakers require particularly high activating temperatures, however, it was of particular interest to find a suitable activator that would allow the bromate breaker to be used at lower temperatures. In some embodiments, the breaking agent may be a bromate breaking agent, a chlorite breaking agent, a peroxide breaking agent, a perborate breaking agent, a percarbonate breaking agent, a perphosphate breaking agent, or a persulfate breaking agent.

The oxidizing breaker may be used in the treatment fluids of the invention in an amount from greater than 0 to about 200% or more by weight of the polymer in the treatment fluid. In certain applications, the breaker may preferably be used in an amount of from about 4% to about 100%, more particularly from about 8% to about 80%, and even more particularly from about 16% to about 25% by weight of the polymer in the treatment fluid. When the breaker is encapsulated for delay, additional levels of breaker can be employed without adversely affecting the fracturing fluid rheology while pumping the treatment.

The breaker/bisulfite reagent is active in various solvents such as pure water, aqueous acetonitrile and aqueous N,N-dimethylacetamide. In one particular embodiment sodium bromate is used as the breaker in combination with a sodium bromate activator. Sodium bromate is inexpensive, nontoxic, stable, and easy to handle compared with liquid bromine, another oxidizer. Furthermore, the sodium bromate/sodium bisulfite reagent is not deactivated when kept at 60° C. for 7 days. Thus the actual oxidant is fairly stable and does not undergo side reactions once the equilibrium has been established. The simple oxidation reaction conditions for the sodium bromate/sodium bisulfite reagent are particularly beneficial to its success.

The actual reaction mechanism involving sodium bromate/sodium bisulfite is very intriguing and not yet clearly understood. It has been thought that a mild oxidizing agent is generated in situ by the addition of both the oxidant (sodium bromate) and the reductant (sodium bisulfite) in solution. The nature of the active oxidant, the role of protons, and the overall mechanism of the substrate oxidation by the sodium bromate/sodium bisulfite system remains elusive. There are postulations that the actual oxidant is hypobromous acid, HOBr (J. Org Chem. 1998, 63, 6023-6026). However, the different bromo-species and potential oxidants HOBrO₂, HOBrO, HOBr, Br₂, Br³⁻ and possibly the Br radical can be produced in the reaction solution in various concentrations. There are reports suggesting that the actual oxidizing agent is Br⁺ or possibly [H₂O—Br]⁺.

The activator for the breaking agent is a compound that provides a source of bisulfite anions in aqueous solution. The bisulfite ion source may be a bisulfite salt or a metabisulfite salt. In particular, the salts include sodium, potassium, lithium or ammonium bisulfite or metabisulfite. The metabisulfites rapidly form bisulfite when added to water. Calcium and magnesium bisulfite can be formed in solution but do not exist as salts, but could also be employed. The bisulfite activator may be used in an amount of from about 2% to about 200% by weight of the polymer in the treatment fluid. In certain applications, the bisulfite activator may be present in the range from about 4% to about 40% by weight of the polymer in the treatment fluid. The amount of activator may depend upon the amount of breaker used and may provide a breaker-to-activator weight ratio of from about 1:1 to about 5:1. In addition to facilitating the use of oxidizing breakers, such as bromate breakers, at lower temperatures, the use of the activator may also eliminate or reduce the need for catalysts, such as copper, chromium, iron, cobalt, manganese, tin, titanate, nickel or arsenic, that are often employed to accelerate the rate of reaction of breakers. Thus, the use of bisulfite as an activator may eliminate the need for adding environmentally unfriendly and possibly toxic heavy metals.

The breaking system components, i.e., the breaking agent and the activator, may initially be in a solid or liquid form. When in a solid form, the materials may be crystalline or granular in nature. The solid forms may be encapsulated or provided with a coating to delay their release into the fluid. Further, the solid may be compounded with other solids to effect a delayed action or to combine two necessary chemicals into one additive. The breaking system components can also be suspended in a carrier fluid in which they are sparingly soluble or insoluble and delivered as a liquid additive. Encapsulating materials and methods of encapsulating breaking materials are known in the art. Such materials and methods may be used for the breaking agent and activators of the present invention. Non-limiting examples of materials and methods that may be used for encapsulation are described, for instance, in U.S. Pat. Nos. 4,741,401; 4,919,209; 6,162,766 and 6,357,527, which are each herein incorporated by reference. When used as a liquid the breaker salt and activator may be dissolved in an aqueous solution before being combined with the treatment fluid. The breakers and activators are soluble in water, that is, they have a solubility of at least greater than 1 g in 100 g of water at room temperature.

Should it be desirable for the breakers or the breaking activators to be coated to delay breaking action, the coating can be done by any known process. Two main types of coating process, top spray and bottom spray, are characterized by the location of the spray nozzle at the bottom or the top of a fluidized bed of solid particles. The nozzle sprays an atomized flow of coating solution while the particles are suspended in the fluidizing air stream that carries the particles past the spray nozzle. The particles then collide with the atomized coating material as they are carried away from the nozzle in a cyclic flow. The temperature of the fluidizing air is set to evaporate solution or suspension liquid media or solidify the coating material shortly after colliding with the particles. The solidified coating materials will cover the particles gradually. This process is continued until each particle is coated uniformly to the desired coating thickness.

The properties of such coated particles can be tuned with the coating formulation, processing conditions, and layering with different coating materials. The choice of material will depend on a variety of factors such as the physical and chemical properties of the material being employed. Coating material can be from one of these categories: aqueous and organic solutions, dispersions, and hot melts. Non-limiting examples include acrylics, halocarbon, polyvinyl alcohol, AQUACOAT® aqueous dispersions, hydrocarbon resins, polyvinyl chloride, AQUATERIC® enteric coatings, HPC, polyvinylacetate phthalate, HPMC, polyvinylidene chloride, HPMCP, proteins, KYNAR®, fluoroplastics, rubber (natural or synthetic), caseinates, maltodextrins, shellac, chlorinated rubber, silicone, COATERIC® coatings, microcrystalline wax, starches, coating butters, milk solids, stearines, DARAN® latex, molasses, sucrose, dextrins, nylon, surfactants, OPADRY® coating systems, SURELEASE® coating systems, enterics, paraffin wax, TEFLON® fluorocarbons, EUDRAGITS® polymethacrylates, phenolics, waxes, ethoxylated vinyl alcohol, vinyl alcohol copolymer, polylactides, zein, fats, polyamino acids, fatty acids, polyethylene gelatin, polyethylene glycol, glycerides, polyvinyl acetate, vegetable gums and polyvinyl pyrrolidone.

The hydratable polymers useful in the present invention may include any hydratable polymers familiar to those in the well service industry that are water soluble and provide a thickening or viscosifying effect to the aqueous fluids in which they are employed when used in appropriate amounts and conditions. Examples of suitable hydratable polymers include, but are not necessarily limited to, guar gums, high-molecular weight polysaccharides composed of mannose and galactose sugars, or guar derivatives such as HPG, CMG, and CMHPG, galactomannan gums, glucomannan gums, and cellulose derivatives. Cellulose derivatives such as hydroxyethylcellulose (HEC), carboxymethylcellulose (CMC), hydroxypropylcellulose (HPC) and carboxymethylhydroxyethylcellulose (CMHEC) may be used. Also, synthetic polymers containing acrylamide are useful, including polyacrylamides, partially hydrolyzed polyacrylamides, copolymers of acrylamide and acrylic acid and copolymers and terpolymers containing acrylamide, vinyl pyrrolidone, AMPS (2-Acrylamido-2-Methyl Propane Sulfonic Acid, or acrylic acid. The viscosifying agent may be heteropolysaccharide viscosifying agent. Heteropolysaccharides such as xanthan gum and those disclosed in U.S. Patent Publication No. US2006/0166836, published Jul. 27, 2006, which is herein incorporated by reference, may be used. The heteropolysaccharide may include those having a tetrasaccharide repeating unit in the polymer backbone as represented by the chemical formula (1):

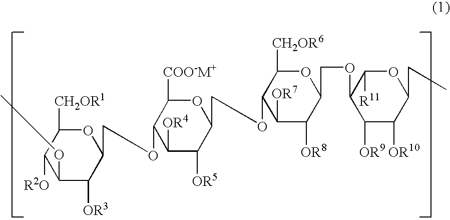

wherein at least three different saccharides are present in the repeating unit, such saccharides including D-glucose, D-glucuronic acid, and either L-rhamnose or L-mannose; M⁺ is an ionic species; R¹, R², R³, R⁴, R⁵, R⁶, R⁷, R⁸, R⁹, and R¹⁰ are selected from the group consisting of hydrogen, methyl, acetyl, glyceryl, or a saccharide group containing one to three saccharides units; R¹¹ is a methyl or methylol group; and the weight average molecular weight (Mw) for the heteropolysaccharide is from about 10⁵ to about 10⁷.

The hydratable polymer may be added in various concentrations to provide the desired viscosity. Concentrations of up to about 1% by weight of total weight of the treatment composition are typically used in fracturing operations, although some specialized gel may contain as much as 8.5% polymer by weight. In certain embodiments of the invention the hydratable polymer may be used in an amount of from about 0.05% to about 0.5% by total weight of the composition.

The polymers may be used in either crosslinked or non-crosslinked form. The polymers may be capable of being crosslinked with any suitable crosslinking agent, such as metal ion crosslinking agents. Examples of such materials include the polyvalent metal ions of boron, aluminum, antimony, zirconium, titanium, chromium, etc., that react with the polymers to form a composition with adequate and targeted viscosity properties for particular operations. The crosslinking agent may be added in an amount that results in suitable viscosity and stability of the gel at the temperature of use. Typically, crosslinkers are added at concentrations of about 5 to about 500 parts per million (ppm) of active atomic weight. That concentration can be adjusted based on the polymer concentration. The crosslinker may be added as a solution and may include a ligand which delays the crosslinking reaction. This delay may be beneficial in that the high viscosity fracturing fluid is not formed until near the bottom of the wellbore to minimize frictional pressure losses and may prevent irreversible shear degradation of the gel, such as when Zr or Ti crosslinking agents are used. Delayed crosslinking may be time, temperature or both time and temperature controlled to facilitate a successful fracturing process.

Other crosslinkers may include organic crosslinkers such as polyethyleneimines, aldehydes, phenol-aldehydes, or urea-aldehydes. Suitable compounds include formaldehyde, formalin, paraformaldehyde, glyoxal, and glutaraldehyde. Compounds which react to form crosslinks include hexamethylenetetramine with phenolic compounds such as phenyl acetate, phenol, hydroquinone, resorcinol, and napthalene diols.

The breaking agent and activator may be used in conjunction with such hydratable polymers, which may be linear or crosslinked. As discussed earlier, conventional bromate breakers are ineffective at temperatures below 250° F. (121° C.). The bromate/bisulfite or metabisulfite breaking system may be used in breaking such viscosified fluids in environments of from about 125° F. (51.7° C.) and higher, more particularly from about 125° F. (51.7° C.) to about 250° F. (121° C.). When used with sodium chlorite, the sodium chlorite/bisulfite or metabisulfite breaking system can be used to break viscosified fluids at temperatures of about 175° F. (79.4° C.) or less. And when ammonium persulfate is the breaking agent, the activator can facilitate breaking at temperatures of about 125° F. (51.7° C.) or less. When these breakers are encapsulated, the temperatures of use can be higher as a certain time delay is afforded by the encapsulation technique.

It is common procedure in fracturing treatments to vary the breaking schedule and breaker chemistry throughout the job. This technique allows a longer breaking time for the fluids that are pumped initially and that experience significant heating and temperature rise and a shorter break time for the fluids that are pumped last and experience only a mild temperature change. Consequently, various combinations of the described breaking systems may be needed on one treatment. As such, some of the breaking systems might be used in formations with temperatures exceeding 350° F. (177° C.) where the injected fluid temperature for some portions of the treatment are expected to rise to no more than 250° F. (121° C.) and might be no more than 77° F. (25° C.).

The polymer-based viscosifier may have any suitable viscosity. The minimum viscosity may be a value that is suitable to carry proppant within the fracturing environment. In certain embodiments, the viscosity may be from about 50 mPa·s or greater at a shear rate of about 100 s⁻¹ at treatment temperature, more particularly about 75 mPa·s or greater at a shear rate of about 100 s⁻¹, and even more particularly about 100 mPa·s or greater. Generally, the maximum viscosity is less than about 1000 mPa·s, more typically, less than about 600 mPa·s at a shear rate of about 100 s⁻¹. Higher viscosities are generally avoided to minimize the cost and the friction while pumping and to promote better clean-up of the fracturing fluid after the fracture has closed and the well is in the production phase.

The breaker/activator breaking system may be used as solids, which are soluble in water, or may be used in liquid form. The breaker and/or activator may be used in dry form, coated, encapsulated or slurried and added to the aqueous fluid at the surface, with or without the hydratable polymer already added. Alternatively, the breaker and/or activator may be contained in a suspension.

In a suspension, the breaking agent and/or activator may be suspended in a non-aqueous or immiscible medium, for example, diesel, mineral oil, etc., prior to mixing with the aqueous fluid and injection into the formation. The suspension may further include a suspension aid, such as hydroxyl propyl cellulose in a glycol ether solvent, such as polyethylene glycol. The breaking agent may also be added on the fly as liquid or pre-mixed in water.

As discussed earlier, in certain applications, the breaking agent may be encapsulated within an encapsulating material to delay reaction with the gelled polymer fluid. Encapsulating materials may include poly n-vinylidene chloride or materials and polymers that are slightly soluble or insoluble in the treatment fluid. The breaking agent can also be compounded with other chemicals to delay dissolution and reactivity.

A breaking delay agent may also be added to the treatment fluid to inhibit or delay reaction of the breaker. Examples of suitable breaking delay agents may include sodium nitrite (NaNO₂), sodium thiosulfate (Na₂S₂O₃), triethanol amine, thiourea and urea. These may be added in an amount from about 2% to about 80% by weight of polymer in the treatment fluid. Delaying agents are particularly useful at higher temperatures, such as at 140° F. (60° C.) or more, where reactions may be accelerated due to the higher temperatures. The breaking delay agent may be encapsulated. Moreover, the breaking delay agent may be encapsulated together with the breaking agent. Alternatively, the breaking delay agent may be delivered separately from the breaking agent. The encapsulating materials for the delaying agent may be those previously described for use with the breaker and/or activator.

It has also been observed that chloride salts, such as potassium chloride, sodium chloride or calcium chloride, which may be employed as a clay stabilizer or in an available brine, can have a delaying effect on the oxidation of the polymer fluid when the breaking system is employed. When higher concentrations of potassium chloride solutions are used, it has been observed that the fluids take longer to break. It is unclear what the exact mechanism is that causes this effect, however, the use of potassium chloride and other similar salts may reduce or eliminate the need for additional delaying agents in certain applications.

Compositions according to the invention may also be applied as foamed or energized well treatment fluids. Such fluids contain “foamers” and may include surfactants or blends of surfactants that facilitate the dispersion of a gas into the composition to form small bubbles or droplets, and confer stability to the dispersion by retarding the coalescence or recombination of such bubbles or droplets. Foamed and energized fluids are generally described by their foam quality, i.e. the ratio of gas volume to the foam volume. If the foam quality is between 52% and 95%, the fluid is conventionally called a foam fluid, and below 52%, an energized fluid. Hence, compositions of the invention may include ingredients that form foams or energized fluids, such as, but not necessarily limited to, foaming surfactant, or blends of surfactants, and a gas or supercritical fluid which effectively forms a foam or energized fluid. Suitable examples of such gases include carbon dioxide, nitrogen, or any mixture thereof.

The gelled polymer solutions, linear or crosslinked, foamed or unfoamed, are particularly useful as carrier fluids for proppants. The proppants may be those that are substantially insoluble in the polymer solution and/or fluids of the formation. In fracturing operations, proppant particles carried by the treatment composition remain in the fracture created, thus propping open the fracture when the fracturing pressure is released and the well is put into production. The proppants may have a particle size of from about 0.08 mm to about 2.5 mm. Suitable proppant materials include, but are not limited to, sand, walnut shells, sintered bauxite, glass beads, ceramic materials, naturally occurring materials, or similar materials. Mixtures of proppants can be used as well. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc.

The concentration of proppant in the composition may be any concentration that is suitable for carrying out the particular treatment desired. For example, the proppant may be used in an amount up to about 3 kilograms of proppant added per liter of the composition. Also, any of the proppant particles may be coated with a resin to potentially improve the strength, clustering ability, and flow back properties of the proppant.

A fiber component may be included in compositions of the invention to achieve a variety of properties including improving particle suspension, and particle transport capabilities, and foam stability. Fibers used may be hydrophilic or hydrophobic in nature. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) fibers available from Invista Corp., Wichita, Kans., USA, 67220. Other examples of useful fibers include, but are not limited to, polylactic acid polyester fibers, polyglycolic acid polyester fibers, polyvinyl alcohol fibers, and the like. When used in compositions of the invention, the fiber component may be included at concentrations from about 1 to about 15 grams per liter of the composition, more particularly the concentration of fibers may be from about 2 to about 12 grams per liter of composition, and more particularly from about 2 to about 10 grams per liter of composition.

Other additives may also be added to the treatment fluid that are known to be commonly used in oilfield applications by those skilled in the art. These may include clay stabilizers, surfactants, anti-foams, high temperature fluid stabilizers, oxygen scavengers, alcohols, scale inhibitors, corrosion inhibitors, fluid-loss additives, bactericides, foaming agents, clean up surfactants, wetting agents, friction pressure reducers, and the like.

In most cases, the fluids of the invention are used in hydraulic fracturing treatments. Hydraulic fracturing consists of pumping a proppant-free composition, or pad, into a well faster than the composition can escape into the formation so that the pressure rises above the fracture pressure of the formation and the rock breaks, creating artificial fractures and/or enlarging existing fractures. Then, proppant particles, such as those previously discussed, are added to the composition to form a slurry that is pumped into the fracture to prevent it from closing when the pumping is ceased and fracturing pressure declines. The proppant suspension and transport ability of the treatment base composition traditionally depends on the viscosity of the fluid. Techniques for hydraulically fracturing a subterranean formation are known to persons of ordinary skill in the art, and will involve pumping the fracturing fluid into the borehole and out into the surrounding formation. The fluid pressure while fracturing is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications”, Encyclopedia of Polymer Science and Engineering, vol. 10, pp. 328-366 (John Wiley & Sons, Inc. New York, N.Y., 1987) and references cited therein.

In the fracturing treatment, compositions of the present invention may be used in the pad treatment, the proppant stage, or both. The components are mixed on the surface. Alternatively, the composition may be prepared on the surface and pumped down tubing while a gas component, such as carbon dioxide or nitrogen, could be pumped down the annulus to mix down hole, or vice versa, to form a foam or energized fluid composition.

In another embodiment, the compositions may be used for gravel packing a wellbore. As a gravel packing composition, it may contain gravel or sand and other optional additives including filter cake clean up reagents such as chelating agents or acids (e.g. hydrochloric, hydrofluoric, formic, acetic, citric acid), corrosion inhibitors, scale inhibitors, biocides, leak-off control agents, among others. For this application, suitable gravel or sand is used typically having a mesh size between 0.2 mm (˜70 mesh) and 2.4 mm (˜8 mesh).

In some embodiments, the compositions described herein may be used as a treatment fluid composition for treating a subterranean formation penetrated by a well bore. In some embodiments, the compositions described herein may be used as a fluid to treat fluids removed from a well, as a fluid for use with pipeline pigging or other applications of thickeners in the oil field services industry. The following examples serve to further illustrate the invention.

### EXAMPLES

The oxidation activity of breaker/bisulfite or breaker/metabisulfite systems was examined using borate cross-linked guar polymer aqueous fluids. Sodium metabisulfite or sodium bisulfite were used to generate the bisulfite anions in aqueous solution. The encapsulated form of sodium metabisulfite was also examined. The evaluation was done using oil bath tests and rheology experiments.

In the examples, the breaker activity was examined at a certain temperature using ALDRICH® stainless steel oil bath (product number Z513172), equipped with DigiTrol II temperature controller (product # Z285498). This set up uses silicone oil (product #146153) and is capable of heating up to 250° C. (482° F.). Degradation of the gel was evaluated visually with time. The pH of the solutions was checked at the beginning and the end of each test. The oil bath was suitable for magnetic stirring and placed on a magnetic stirrer for the experiments. Only Pyrex glass bottles were used in the oil bath. Above 170° F. (76.7° C.), 20 mL chromatographic vials, equipped with viton plug and crimp top containing 15 mL of polymer fluid were used.

Rheology was measured using a Grace M5500 viscometer, available from Grace Instrunent Co., using a number 1 rotor and a number 5 bob. This model 50 viscometer conforms to the specification in standard ISO 13503-1, Measurement of viscous properties of completion fluids. The viscosities were reported at a shear rate of 100 s⁻¹.

Examples 1 through 5 employed an 18 lb base solution (i.e. 18 lb gel/1000 gal or 2.16 kg gel/1000 L) prepared by hydrating 2.16 gm of guar gum in 1.0 liter deionized (DI) water, using a blender for 20 minutes. The solution contained 20 gm of potassium chloride as a clay stabilizer (2% solution). The linear fluid was then crosslinked by adding 2.5 mL of a borate crosslinker fluid containing 15.7 wt % of sodium tetraborate decahydrate. The final pH of the crosslinked fluids were in the range of 10.5 to 11. Example 4 contained a crosslinked guar fluid where 4 wt % potassium chloride was used instead of 2%. Example 6 utilized a 15 lb base solution (i.e. 15 lb/1000 gal or 1.8 kg gel/1000 L

### Example 1

Tests were conducted using sodium bromate as a breaker and sodium bisulfite as its activator. Oil bath tests performed at 175° F. (79.4° C.) for 3 hours exhibited that 0.06 wt % of sodium bromate in absence of the activator was unable to break the fluid at this temperature, whereas, the fluid samples that contained additional sodium bisulfite of 0.012 and 0.024 wt %, respectively, degraded the fluid completely.

### Example 2

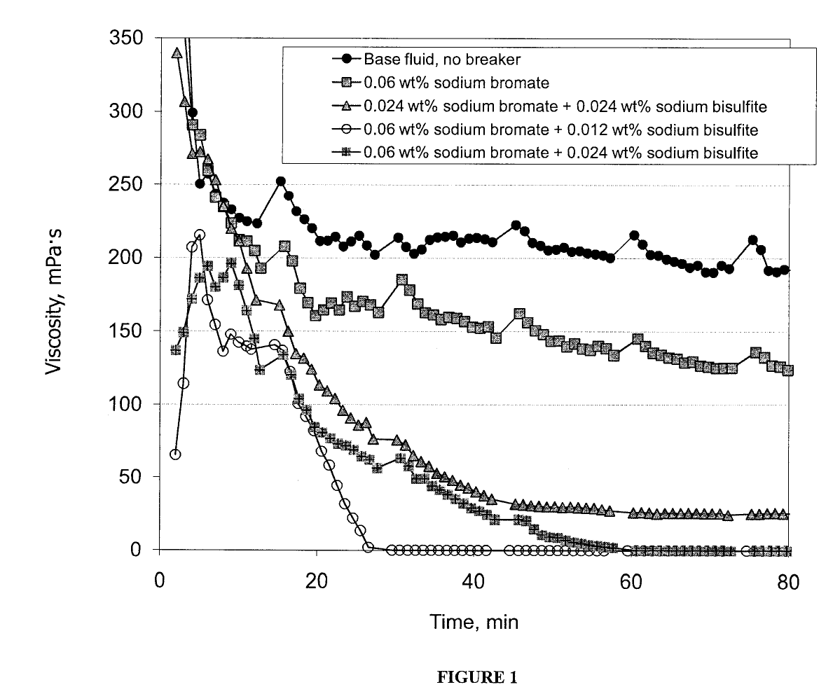

As a comparison, Theological studies were conducted using the crosslinked guar solution without a breaker, with 0.06% sodium bromate breaker without any activator, and the combination of both breaker and sodium bisulfite at different concentrations and ratios, as shown in FIG. 1. As can be seen in FIG. 1, the sodium bromate itself was not capable of oxidizing the fluid. The bromate/bisulfite system was able to oxidize the fluid and reduce the viscosity at 175° F. (79.4° C.).

### Example 3

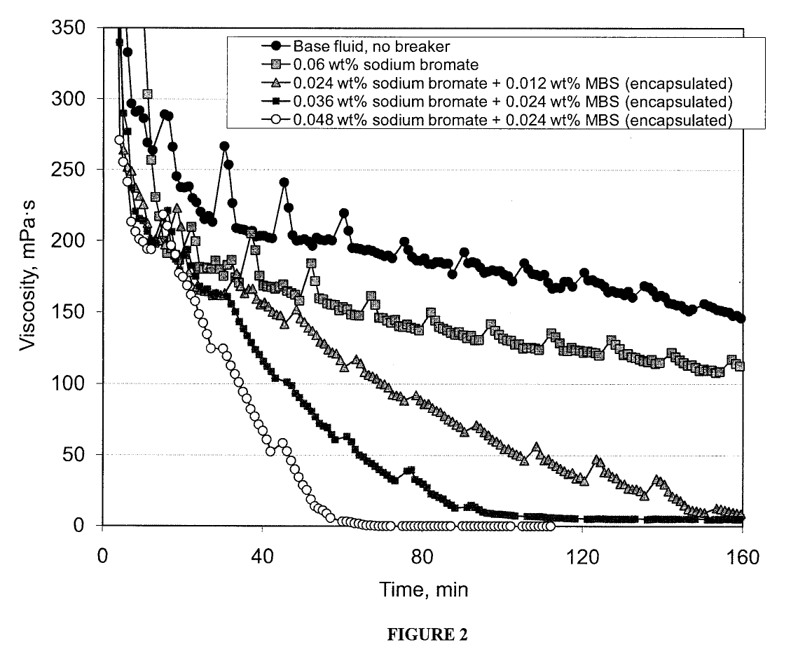

Encapsulated sodium metabisulfite particles containing 70% by weight of MBS coated with 30% by weight of polyvinylidene chloride were also tested as the activator for sodium bromate in order to obtain delayed breaking of the crosslinked fluid. The rheology data are shown in FIG. 2, where different concentrations and different ratios of sodium bromate and encapsulated MBS were employed. Delayed breaking was observed depending on the concentration. The data was consistent with the corresponding oil bath test results. It was noticed that the pH decreased when using bisulfite or MBS, but no decrease was observed when using the encapsulated form of MBS. In the case of borate fracturing fluids, the fluids can lose viscosity when the pH decreases as the borate crosslinker converts to boric resulting in lower active crosslinker. The decrease in pH can be compensated for by addition of a base such as sodium hydroxide to the fluid.

### Example 4

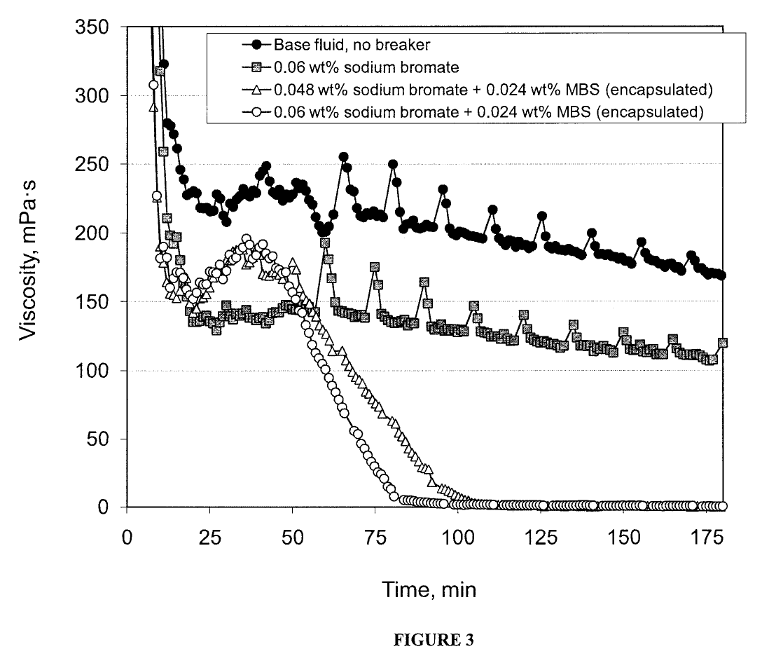

Increased concentration of potassium chloride, which may be used as a clay stabilizer, delays the oxidation of the polymer fluid. FIG. 3 shows that when the amount of potassium chloride was increased from 2 wt % to 4 wt %, the fluid sample took longer to be oxidized for the same amount of breaker and the activator. When 0.048% by weight of sodium bromate bromate and 0.024% by weight of MBS were used in a fluid containing 2% potassium chloride, the complete reduction of the viscosity of the fluid occurred at about 60 minutes (see FIG. 2). On the other hand, at the same temperature in presence of 4% potassium chloride, with the same amount of sodium bromate and MBS, the fluid was broken after about 100 minutes (see FIG. 3).

### Example 5

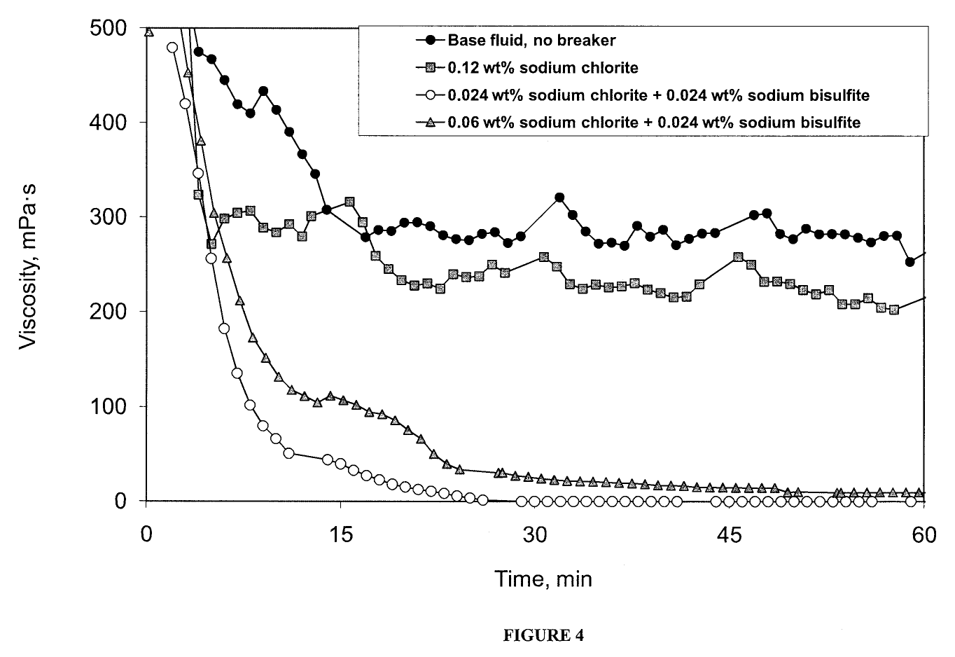

Sodium chlorite was used as the breaking agent in different amounts with and without sodium bisulfite activator in a crosslinked guar gel. As can be seen in FIG. 4, the fluids in the absence of sodium chlorite or with sodium chlorite only did not break at a temperature of 175° F. (79.4° C.). When used with the activator, even when lower amounts of the sodium chlorite breaker were used, the fluids broke readily. No heavy metals were needed for catalyzing the sodium chlorite at 175° F. (79.4° C.).

### Example 6

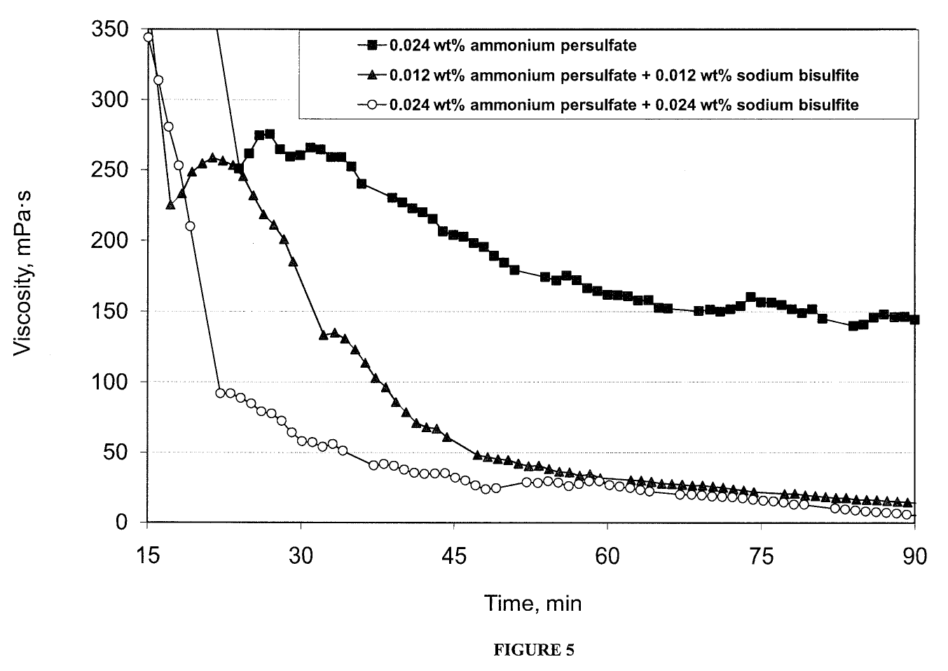

Ammonium persulfate was used as the breaking agent in different amounts with and without sodium bisulfite activator in a crosslinked guar gel. As can be seen in FIG. 5, the fluid without added sodium bisulfite activator did not break at a temperature of 100° F. (37.8° C.). When used with the activator at the same temperature, the fluids broke.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A treatment fluid composition for treating a subterranean formation, the composition comprising:
an aqueous fluid;
a hydratable polymer; and
a polymer breaking system, said system comprising an oxidizing breaking agent and an activator capable of providing a bisulfite ion source.

2. The composition of claim 1, further comprising:
a crosslinking agent capable of crosslinking the hydratable polymer.

3. The composition of claim 1, wherein the oxidizing breaking agent is selected from at least one of a bromate breaking agent, a chlorite breaking agent, a peroxide breaking agent, a perborate breaking agent, a percarbonate breaking agent, a perphosphate breaking agent, or a persulfate breaking agent.

4. The composition of claim 3, wherein the bromate breaking agent is selected from at least one of potassium, sodium, lithium or ammonium bromate.

5. The composition of claim 1, wherein the activator comprising the bisulfite ion source is selected from alkaline metal solids or solutions of bisulfite, alkaline metal solids or solutions of metabisulfite, ammonium solids or solutions of bisulfite, ammonium solids or solutions of metabisulfite, alkaline earth solutions of bisulfite and alkaline earth solutions of metabisulfite.

6. The composition of claim 5, wherein the activator is selected from sodium bisulfite, potassium bisulfite, ammonium bisulfite, lithium bisulfite, sodium metabisulfite, potassium metabisulfite, ammonium metabisulfite and lithium metabisulfite.

7. The composition of claim 1, wherein the breaking agent, the activator or both are at least one of encapsulated form, coated form or contained in a suspension.

8. The composition of claim 1, wherein the polymer is selected from polysaccharides, galactomannans, guar, guar gums, guar derivatives, cellulose and cellulose derivatives, polyacrylamides, partially hydrolyzed polyacrylamides, copolymers of acrylamide and acrylic acid, terpolymers containing acrylamide, vinyl pyrrolidone, 2-acrylamido-2-methyl propane sulfonic acid and heteropolysaccharides having a tetrasaccharide repeating unit in the polymer backbone as represented by the chemical formula: 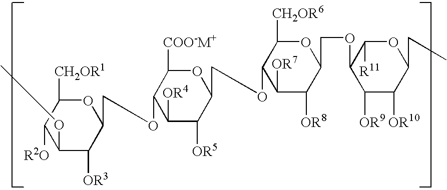
wherein at least three different saccharides are present in the repeating unit, such saccharides including D-glucose, D-glucuronic acid, and either L-rhamnose or L-mannose; M⁺ is an ionic species; R¹, R², R³, R⁴, R⁵, R⁶, R⁷, R⁸, R⁹, and R¹⁰ are selected from the group consisting of hydrogen, methyl, acetyl, glyceryl, or a saccharide group containing one to three saccharides units; R¹¹ is a methyl or methylol group; and the weight average molecular weight (Mw) for the heteropolysaccharide is from about 10⁵ to about 10⁷.

9. The composition of claim 1, wherein the breaking agent is an alkaline metal bromate, ammonium bromate or an alkaline earth bromate.

10. The composition of claim 1, wherein the breaking agent is combined with the treatment fluid in an amount from greater than 0% to about 200% by weight of the polymer in the treatment fluid and the activator is combined with the treatment fluid in an amount from about 1 to about 200% by weight of the polymer in the treatment fluid.

11. The composition of claim 10, wherein the breaking agent is combined with the treatment fluid in an amount from about 8% to about 80% by weight of the polymer in the treatment fluid and the activator is combined with the treatment fluid in an amount from about 4% to about 40% by weight of the polymer in the treatment fluid.

12. The composition of claim 1, further comprising a breaking delay agent.

13. The composition of claim 12, wherein the breaking delay agent is selected from at least one of NaNO₂, NaNO, Na₂S₂O₃, triethanol amine, thiourea and urea.

14. The composition of claim 1, wherein the composition is a foamed or energized fluid.

15. A method of treating a subterranean formation penetrated by a wellbore, the method comprising:
forming a treatment fluid of an aqueous hydrated polymer solution and a polymer breaking system, the polymer breaking system comprising a breaking agent of an oxidizer and an activator capable of providing a bisulfite ion source; and
introducing the treatment fluid into the formation.

16. The method of claim 15, wherein the treatment fluid is formed from an aqueous crosslinkable hydrated polymer solution and a crosslinking agent capable of crosslinking the polymer.

17. The method of claim 15, wherein the oxidizing breaking agent is selected from at least one of a bromate breaking agent, a chlorite breaking agent, a peroxide breaking agent, a perborate breaking agent, a percarbonate breaking agent, a perphosphate breaking agent, or a persulfate breaking agent.

18. The method of claim 17, wherein the bromate breaking agent is selected from at least one of an alkaline metal bromate, ammonium bromate or an alkaline earth bromate.

19. The method of claim 15, wherein the activator comprising the bisulfite ion source is selected from alkaline metal solids or solutions of bisulfite, alkaline metal solids or solutions of metabisulfite, ammonium solids or solutions of bisulfite, ammonium solids or solutions of metabisulfite, alkaline earth solutions of bisulfite and alkaline earth solutions of metabisulfite.

20. The method of claim 15, wherein the polymer is selected from polysaccharides, galactomannans, guar, guar gums, guar derivatives, cellulose and cellulose derivatives, polyacrylamides, partially hydrolyzed polyacrylamides, copolymers of acrylamide and acrylic acid, terpolymers containing acrylamide, vinyl pyrrolidone, 2-acrylamido-2-methyl propane sulfonic acid and heteropolysaccharides having a tetrasaccharide repeating unit in the polymer backbone as represented by the chemical formula: 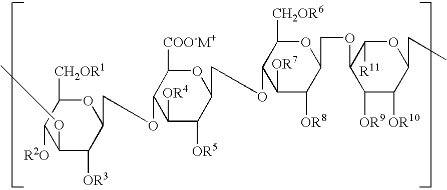
wherein at least three different saccharides are present in the repeating unit, such saccharides including D-glucose, D-glucuronic acid, and either L-rhamnose or L-mannose; M⁺is an ionic species; R¹, R², R³, R⁴, R⁵, R⁶, R⁷, R⁸, R⁹, and R¹⁰ are selected from the group consisting of hydrogen, methyl, acetyl, glyceryl, or a saccharide group containing one to three saccharides units; R¹¹ is a methyl or methylol group; and the weight average molecular weight (Mw) for the heteropolysaccharide is from about 10⁵ to about 10⁷.

21. The method of claim 15, wherein the breaking agent is selected from at least one of potassium, sodium, lithium or ammonium bromate.

22. The method of claim 15, wherein the step of introducing the treatment fluid into the formation comprises injecting the treatment fluid into a portion of the formation having a static temperature from about 25° C. to about 177° C.

23. The method of claim 15, wherein the treatment fluid is introduced at a pressure above the fracture pressure of the formation.

24. The method of claim 15, wherein the breaking agent is combined with the treatment fluid in an amount from greater than 0% to about 200% by weight of the polymer in the treatment fluid and the activator is combined with the treatment fluid in an amount from about 1 to about 200% by weight of the polymer in the treatment fluid.

25. The method of claim 15, wherein the breaking agent is combined with the treatment fluid in an amount from about 8% to about 80% by weight of the polymer in the treatment fluid and the activator is combined with the treatment fluid in an amount from about 4% to about 40% by weight of the polymer in the treatment fluid.

26. The method of claim 15 wherein the breaking agent, the activator or both are at least one of encapsulated, coated or contained within a suspension.

27. The method of claim 15, wherein the treatment fluid further comprises a breaking delay agent.

28. The method of claim 15, wherein the treatment fluid is introduced into the formation during at least one of a fracturing operation and a gravel packing operation.
